(19) United States
(12) Patent Application Publication
(10) Pub. No.: US 2017/0059092 A1
(43) Pub. Date: Mar. 2, 2017

(54) NANO-SENSOR EMBEDDED PIPELINE SYSTEM

(71) Applicant: Mohammed Zulfiquar, Birmingham (GB)

(72) Inventor: Mohammed Zulfiquar, Birmingham (GB)

(21) Appl. No.: 15/242,623

(22) Filed: Aug. 22, 2016

Related U.S. Application Data
(60) Provisional application No. 62/208,901, filed on Aug. 24, 2015.

(51) Int. Cl. F17D 3/00; F17D 5/06; H04Q 9/00

(52) U.S. Cl. CPC F17D 3/00; H04Q 9/00; F17D 5/06

(57) ABSTRACT

A nano-sensors embedded pipeline system where the system comprises a plurality of pipeline, a plurality of nano-sensors, a local control unit communicably configured to the nano-sensors, a computing device communicable configured to the local control unit and a communication system. The method of using the pipeline system, where the method comprises of accepting the real time data of the pipeline by nano-sensors, transferring the real time data to the local control unit, wherein the local control unit stores the data as information, sorting the information on the basis of a plurality of parameters, wherein the parameters are predefined, receiving the sorted information as input signal by the computing device; wherein the computing system stores and processes the received signal and generating an action which is sent as an output signal to the local control unit. The pipelines of nano-sensor embedded pipeline system are polymer or metal based pipelines.

### TECHNICAL FIELD

Embodiments described herein relate to the field of data collection and fail-safe control system of a pipeline system. More particularly to the field of collecting data captured by plurality of nano-sensors embedded in the pipeline system and use the data as a feed for fail-safe control system of the pipeline system.

### BACKGROUND

The developing national economy is leading to the rational use of the underground space especially in urban regions. Hence underground pipelines are important in cities to potentially use the underground space. The underground pipelines are the most convenient mode of transportation of fluids and gases through the cities. At the same time maintenance of these pipelines are crucial from leakage and theft.

Leakage in the pipelines is great threat to environment, which badly affects surroundings and living beings around the leakage area. Furthermore, the pipelines may carry flammable or explosive material such as oil and natural gas which makes it further necessary to stop the leakage to avoid any major incidents or accidents. Also, the pipes may carry sewage material which if leaked can be cause of infection and public nuisance.

In view of the above mentioned scenario it is required that the government should make certain regulations or make some internal policies to ensure the safety of the population, environment and the pipelines where they are being installed.

Various efforts and technologies have been implemented to ensure pipeline safety. These methods or tools include conducting statistical analysis, performing airborne reconnaissance, regular monitoring of pressure in the pipelines, using Computational Pipeline Monitoring (CPM) software, etc. However, these methods and tools are limited in respect of the factors required to be monitored in a particular region of the pipeline for which an exhaustive separate analysis is made on the pipes before installation.

Various efforts and technologies have been done also to predict the fail-safe of pipelines system. A collection of sensors system responsible for reading different aspect of the pipeline has been applied as a cover around the pipeline to collect the critical data. But the covering of pipelines with a sensor system is cumbersome and costly work which has a number of negative aspects such as transportation of such pipes to the pipeline system and complete covering of the pipes.

Unfortunately, the lack of innovation and effective investment in research and development to address these issues has meant that the solutions 20 years ago are no different to the ones offered today by servicing companies. Accordingly, there exists a need for innovation in relation to the pipeline integrity, where the entire pipeline is prevented or monitored on a regular basis. Also, there exists a need to reduce the delay in generating data corresponding to the leakage or theft from the pipeline system. Further, there is a need to generate systems which have reduced turnaround time in the cases of leakage and theft.

### SUMMARY

The present invention aims to provide a method and a system to collect and collate the data from the nano-sensors. More particularly, the system should be able to collect the data from the plurality of nano-sensors which are embedded in pipes of a pipeline system. These nano-sensors are required to monitor any changes that the pipeline system may undergo due to changes in the surrounding conditions and generate real time data relating to the pipeline system, where the data relates to pipeline leakage, prediction of stress and strain, fatigue measurement, corrosion and erosion, future leakage or failure, and detection of any attempt to theft or tempering in the pipeline system. The data generated by modules shall be transferred efficiently to a computing device via a local control unit. More particularly, embodiments described herein relate to the method and the system of data collection from the embedded nano-sensors assembled in the pipeline system.

However, this summary is not an extensive overview of the disclosure. It is intended to neither identify key or critical elements of the disclosure, nor to delineate the scope of the present disclosure. Rather, the sole purpose of this summary is to present some concepts of the disclosure, its objects, and advantages in a simplified form as a prelude to the more detailed description that is presented hereinafter.

The present object of the invention is to develop the system and method which is required for the collection of a large amount of data from the embedded nano-sensors assembled in the pipeline system.

A further object of the invention is that the system should be able to collect the real time data from the embedded nano-sensors to protect the pipeline system from leakage, theft and to access the future leakage so that protective measures can be taken on time.

A further object of the invention is that the real time data should cover all the parameters of the pipeline system in a cost effective manner.

A further object of the invention is that the embedded nano-sensors pipeline systems can be used as the household pipeline system.

A further object of the invention is to embed the nano-sensors in pipes of a pipeline system using a specialized machine for direct sensor printing onto pipelines.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1. illustrates block diagram of a nano-sensors embedded pipeline protection system

FIG. 2. illustrates the diagram of the embedded nano-sensors electronic circuit assembled in the polymer/metal sheet

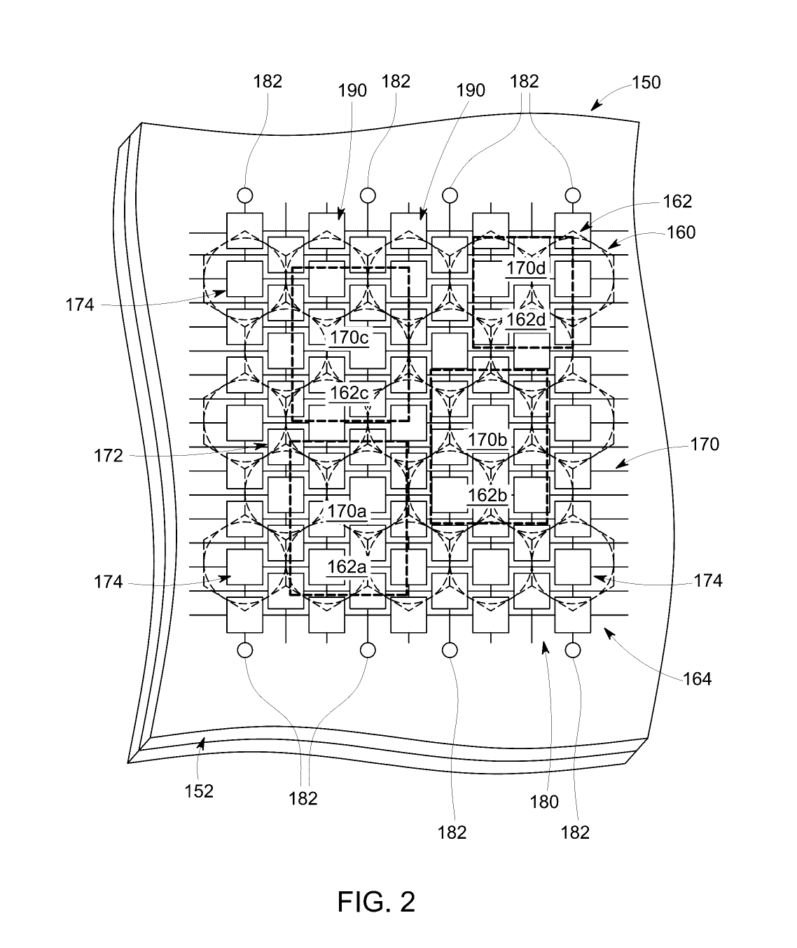

FIG. 3. illustrates the pipeline embedded with plurality of nano-sesnors.

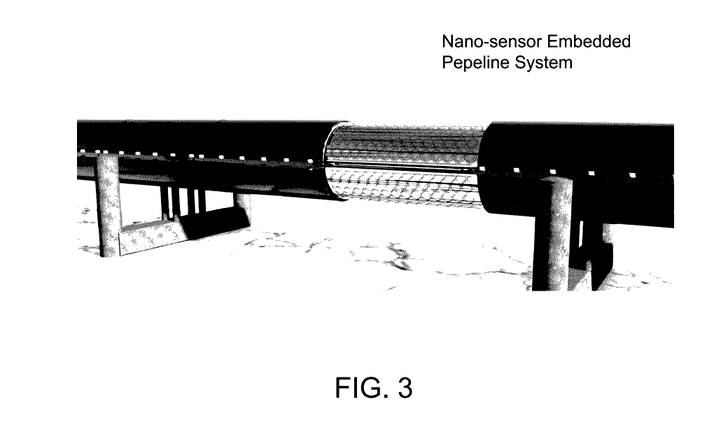

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

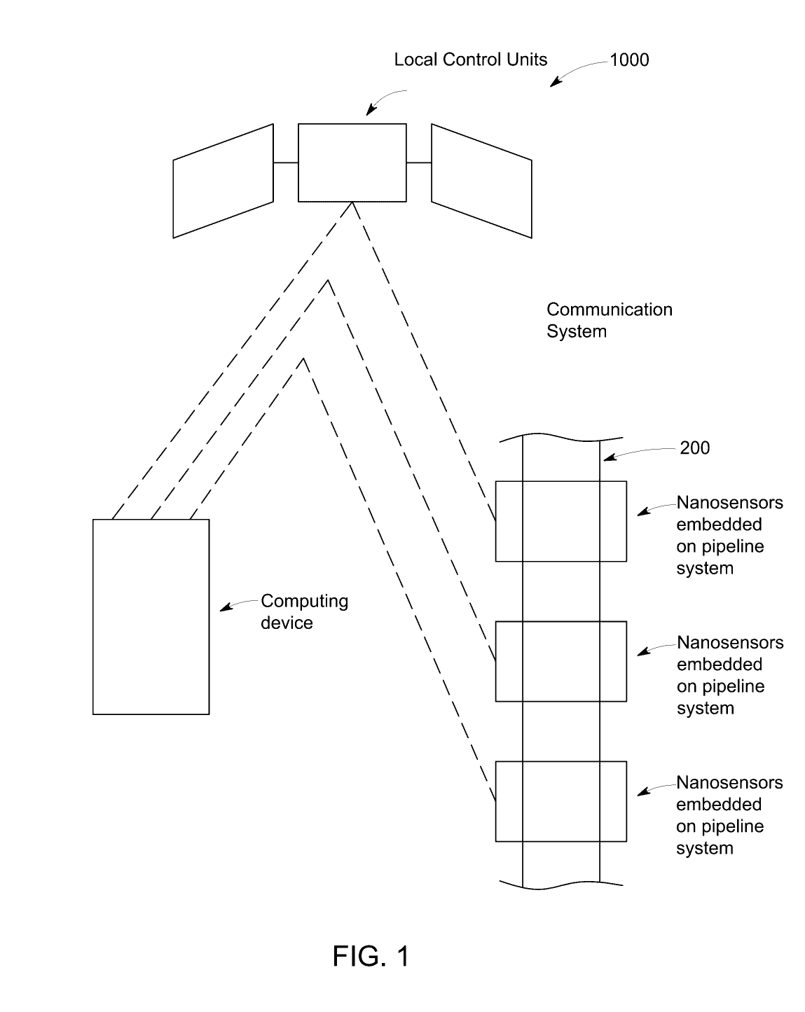

The above noted and other objects, in one aspect, may be achieved by a system of the present disclosure. The system disclosed includes a pipeline system with nano-sensors embedded in the pipeline. The system comprises plurality of pipes, plurality of nano-sensors, a local control unit, a computing device and a communication system. The nano-sensors are adapted to be communicably configured to local control unit, and further the local control unit is communicably linked to the computing device through the communication system (FIG. 1).

In one embodiment, the plurality of nano-sensors is embedded into pipelines of the pipeline system By using a specialized machine by direct sensor printing. The nano-sensors are provided with electronic circuit. A combinational arrangement of all the above when embedded within the pipeline are able to generate a plurality of real time data relating to the pipeline, such as pipeline leakage, prediction of stress and strain, fatigue measurement, corrosion and erosion, future leakage or failure, and detection of any attempt to theft or tempering in the pipeline. Further, all the real time data that is generated using the nano-sensors is collected and transferred to a local control unit.

In one of the embodiment, the nano-sensors can sense even small quantities of molecules and/or compounds. Further, the nano-sensors can sense a single molecule also. By using this capacity of nano-sensors even the slightest of leakage can be detected.

In one of the preferred embodiment, the nano-sensors electronic circuit comprises nanowires. The nano-sensors are connected to each other using these nanowires and they further connect to the local control unit.

In one of the preferred embodiment, if any leakage is detected by the nano-sensors, the detected signal is transmitted via nanowires till it reaches the local control unit. The signal transmission across nanowires is done by free electrons which travel through the wires.

In one of the embodiment, the local control unit which is adapted to communicably configure with the plurality of nano-sensors receives such real time data relating to the pipeline system and the data received is stored at the local control unit.

In one of the embodiment, the local control unit stores the plurality of information in a local database. Further, the storage of information in the local database helps to arrange the data into the meaningful information.

In one of the embodiment, the local control unit analyzes the stored meaningful information and segregates the information into critical information and non-critical information. The information is critical or not can be decided on the basis of the parameters provided to the database.

In one of the embodiment, the local control unit is communicably linked to a computing device. Further, the communication of information to the computing device is decided on the basis of the segregation of the data.

In one of the embodiment, the local control unit passes only the critical information to the computing device. The transfer of only critical information to the computing device reduces the overall burden on electronic circuit. The reduction in amount of data speeds up the data transfer process.

In one of the embodiment, the critical data is transferred to the local database is received as an input signal by the computing device. The computing device receives the input signal, stores and processes the signal, and then generates an action which is sent as an output signal.

In one of the preferred embodiment, the output signal generated is converted into meaningful information that is transmitted as human interpretable information.

In one of the preferred embodiment, the human interpretable information is displayed as a warning message.

In one of the preferred embodiment, the parameters provided to the computing devices are self-adjusted. The self-adjustment of the parameters is done by using the Artificial Neural Network (ANN) module. This will provide Artificial Intelligence to the entire pipeline system and the turnaround time for action based on information will reduce.

In one of the preferred embodiment, at least one of the nano-sensors is a Global Positioning System (GPS) nano-sensor, to enable the communication between the plurality of modules and the local control unit. In one of the preferred embodiment, the communication of the information between modules, local control unit and remote server is done through GPS.

In one of the preferred embodiment, the pipes used in the pipeline system are polymer pipes.

In one of the preferred embodiment, the pipes used in the pipeline system are metallic pipes.

In one of the preferred embodiment, the pipeline system can be used as a household pipeline system.

What is claimed:

1. A pipeline system comprises:
a. a plurality of pipes;
b. a plurality of nano-sensors, wherein the nano-sensors are embedded in pipes;
c. a local control unit communicably configured to the nano-sensors;
d. a computing device communicable configured to the local control unit; and
e. a communication system.

2. The nano-sensors as claimed in claim 1, wherein the nano-sensors collect the real time data from the pipeline system.

3. The nano-sensors as claimed in claim 1, wherein the nano-sensors are embedded in the pipeline system.

4. The nano-sensors as claimed in claim 1, wherein the nano-sensors are GPS nano-sensors.

5. The local control unit as claimed in claim 1, wherein the local control unit is associated to a local database.

6. The local database as claimed in claim 5, wherein the local database stores and interprets the real time data as sent by nano-sensors.

7. The local database as claimed in claim 5, wherein the database is linked to a self-training module of the local control unit, the training module is Artificial Neural Network.

8. The pipes as claimed in claim 1, wherein the pipes are polymer based pipes.

9. The pipes as claimed in claim 1, wherein the pipes are metallic pipes.

10. The communication system as claimed in claim 1, wherein the communication system is a GPS communication system.

11. The method of using the pipeline system as claimed in claim 1, wherein the method comprises the following steps:
a. accepting the real time data of the pipeline by embedded nano-sensors;
b. transferring the real time data to the local control unit, wherein the local control unit stores the data as information;
c. sorting the information on the basis of plurality of parameters, wherein the parameters are predefined;
d. receiving the sorted information as input signal by the computing device; wherein the computing system stores and processes the received signal; and
e. generating an action by the computing device which is sent as an output signal to local control unit.

12. The method as claimed in claim 11, wherein the local control unit has a local database for the storing and sorting of informations.
